(19) United States
(12) Patent Application Publication
(10) Pub. No.: US 2021/0092127 A1
(43) Pub. Date: Mar. 25, 2021

(54) WRITING ROLE-BACKED ACCESS CONTROL TO CHAIN

(71) Applicant: Microsoft Technology Licensing, LLC, Redmond, WA (US)

(72) Inventors: Zhen LI, Bellevue, WA (US); Isaac Thomas WOODEN, Bothell, WA (US)

(73) Assignee: Microsoft Technology Licensing, LLC, Redmond, WA (US)

(21) Appl. No.: 16/575,546

(22) Filed: Sep. 19, 2019

(51) Int. Cl. H04L 29/06; G06F 16/23; H04L 9/06; G06F 8/70

(52) U.S. Cl. CPC H04L 63/105; G06F 16/2365; H04L 2209/38; H04L 9/0637; G06F 8/70; G06F 16/2379

(57) ABSTRACT

Aspects of the technology described herein provide synchronization and access control of data between multiple parties in a blockchain consortium. An executable file is provided that includes an on-chain metadata repository or an address of an off-chain metadata repository interface for storing user, organization, and application metadata for application usage. Various roles and access control functions may be defined in the executable file that can be used to enforce access control logic on-chain for state-modifying transactions. An organization administrator role may enable a person assigned that role to add/modify metadata repository data on behalf of an organization. A replicator is provided that is configured to provide source code verification. The replicator provides an interface for accessing the source code of a distributed application for verifying the code for increased data security. The replicator may further replicate the code and provide a URL for enabling other parties to access the code.

### BACKGROUND

A technical problem associated with consortium blockchain systems is providing synchronization and access control of various data among multiple parties in the consortium where the parties may or may not be in a trust relationship. For example, a consortium blockchain refers to a blockchain where various organizations participate in its management. The blockchain is based on a peer-to-peer network that links its members, where members participate in the network through a blockchain client node. The organizations involved may have different goals and priorities and, in some aspects, may be in competition with each other, while in other aspects, may be partners for a shared benefit, such as to leverage information to improve workflows, accountability, and transparency.

The data structure of a blockchain is a ledger, which includes a linked list of blocks comprising transactions. Each element of the list has a pointer to the previous block and represents its hash value. To add data to the blockchain, a participant node may send a transaction request to the network. Blockchains are run by machines (e.g., virtual machines) that enable networking, consensus, and state management. These machines may run application-layer software that is responsible for updating state. The application-layer software may be a computerized transaction protocol, such as an executable file, configured to digitally allow for the application of a transaction to the ledger by verifying, and enforcing the negotiation or performance of a contract. For example, an executable file allows the implementation of transactions without the need for a third party intermediary. Currently, there is a need for increased security in a consortium blockchain to regulate state-changing transactions on the blockchain. It is with respect to these and other general considerations that embodiments have been described. Also, although relatively specific problems have been discussed, it should be understood that the embodiments should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

For example, a problem with participating in a consortium blockchain is a lack of on-chain access control, such as access control around a particular distributed application, the modification process for the application, how it uses confidentiality primitives, etc. Without access control on a distributed application, any party in the consortium may be able to call into a state-transitioning function arbitrarily and change state. Moreover, it may be desired to implement access control in association with the software development lifecycle of a distributed application (e.g., controls around who is allowed to perform upgrades, who has rights to deploy new instances of the application, who can modify the application).

To implement access control, various data may need to be shared and synchronized across parties of the consortium, such as user information, organization information, and application information. Currently, in a consortium blockchain, the identity of a participant node is defined by the participant's cryptographic asymmetrical key pair. The public key is derived to obtain a unique address, which serves as the participant's public identity, and the private key is used to sign transactions and guarantee their authenticity (i.e., other participants can verify the signature using the associated public key). The unique address obtained from the participant's public key may be a hexadecimal string (e.g., 160 bit). While the hexadecimal string may uniquely identify a participant on the blockchain, it does not reveal information about who is sending/receiving a transaction, the organization to which the participant belongs, etc. Thus, when generating a distributed application, it may be helpful to have access to certain information (e.g., user information, organization information) such that the party generating the application can specify which organizations and/or individuals may execute particular functions in the application associated with state-changing transactions. Further, the information may need to be synchronized so that each party has access to current information.

Additionally, there is a need for secure access to particular data stored off-chain. Currently, when a distributed application is deployed by a party on the consortium blockchain, other parties may only have access to a compiled version of the application, which like a participant's unique address, may be a hexadecimal string. Again, in a consortium, various members or organizations may not fully trust one another. Because of this or other reasons, another party in the consortium may want access to the source code, such as to verify the code (e.g., detect bugs, vulnerabilities, malicious code), to understand the logic behind the application, etc.

Aspects of the present disclosure describe systems and methods for providing an application-level governance framework based on leveraging a blockchain ledger network to accomplish data synchronization and access control in a consortium network. According to an example aspect, an executable file, such as a smart contract, may be generated and embedded onto a consortium blockchain, wherein the executable file comprises an “on-chain” metadata repository for recording user metadata, organization metadata, and application metadata. The executable file may be configured to store data “inside of itself” where only members of the consortium may have access to view the recorded information. The executable file may further include logic for determining who can modify its data along with other functions. Accordingly, the executable file can be used to record user metadata, organization metadata, and application metadata on-chain, wherein the multiple parties in the consortium have access to the data and can be kept in sync of changes to this data. In some examples, the metadata repository includes registry data (e.g., user metadata, organization metadata, and application metadata) that is stored directly on the blockchain (i.e., the metadata repository is included in the executable file). In other examples, the metadata repository is accessible from the blockchain (e.g., via a link stored on the blockchain to an interface for an off-chain metadata repository). According to an aspect, each organization in the consortium network may include one or more organization administrator roles that may be defined in the executable file to enable a person assigned the role to add or modify registry data on behalf of the organization. Aspects provide data privacy for registry data. For example, registry data can be kept private from parties who leave the consortium by updating the link interface information (e.g., provide a new URL with a new embedded key). Accordingly, if a party leaves the consortium, the access of registry data to the leaving party is revoked.

According to another aspect, various roles and access control functions may be included in the executable file. In this way, the registry data and roles information stored in the executable file can be used to enforce access control logic on-chain for state-modifying transactions on the registry data (e.g., modifying organization metadata, adding user metadata, modifying user metadata, adding application metadata, modifying application metadata). Further, aspects provide for enabling one or more distributed applications to be generated and deployed on the consortium blockchain. The one or more distributed applications may be configured to use the executable file as a backend for executing contractual clauses when a preprogrammed condition is triggered. For example, the preprogrammed conditions may be defined by function parameters, that when satisfied, cause the executable file to perform an event that is recorded as a transaction on the consortium blockchain. In example aspects, a role may be referenced by a distributed application for enabling access control of a function in the application. The distributed application may include instructions that, when the access-controlled function is called, call the executable file to access role information and logic included in the executable file for verifying whether the individual is associated with a role that is allowed to perform the access-controlled function.

Aspects further include providing a mechanism by which a consortium member can access and verify source code of a distributed application stored in off-cloud storage of another node. For example, aspects may include a replicator configured to provide an interface to the off-cloud storage. Another consortium node can make a call to the replicator to access the source code, compile it, generate a hash of the code, and compare the hash to a hash of the distributed application deployed on the consortium blockchain. For example, if the hashes match, the consortium member can be ensured that the code that they are interacting with on the consortium blockchain has not been compromised. Additionally, a replicator instance on the other consortium node may be configured to react to a change on the distributed application by replicating the accessed source code, storing the replica in an off-cloud storage on the other consortium node, and add the URL of the replicator to the executable file metadata repository so that the replica of the source code can be made available to other consortium members. Accordingly, increased data security is provided.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process. The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment for implementation of the present disclosure;

FIG. 2 is a block diagram showing an example computing system architecture for implementing aspects of the present disclosure;

FIGS. 3A-3I illustrate an example executable file including an on-chain metadata repository;

FIGS. 4A-4B are a flow chart showing general stages involved in an example method for leveraging a blockchain ledger network to provide data synchronization and access control in a consortium network;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

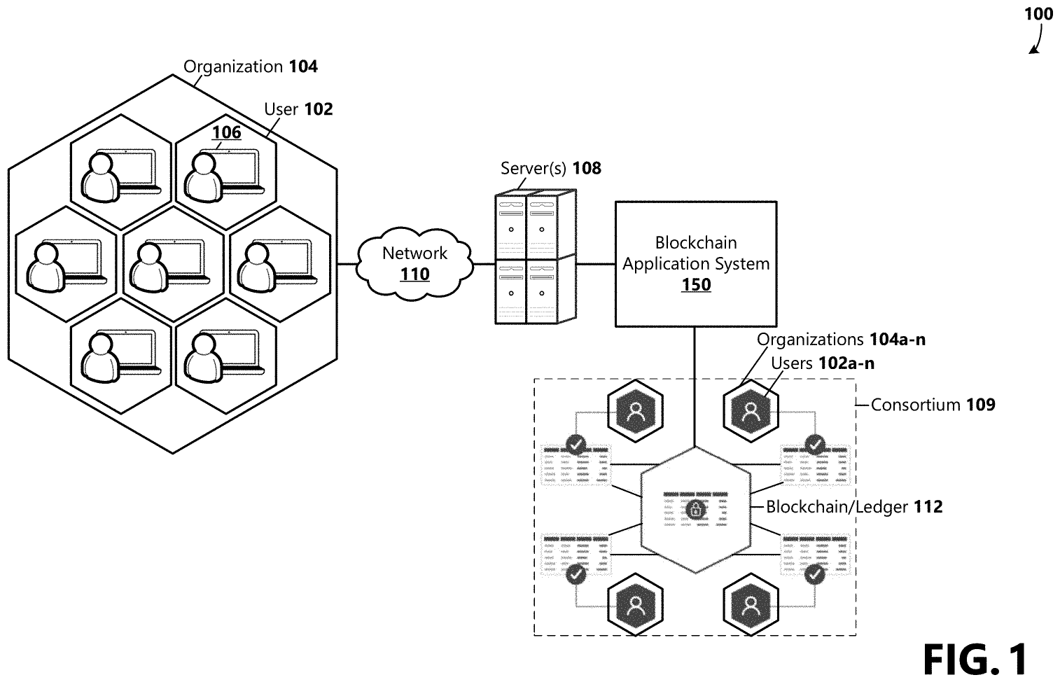

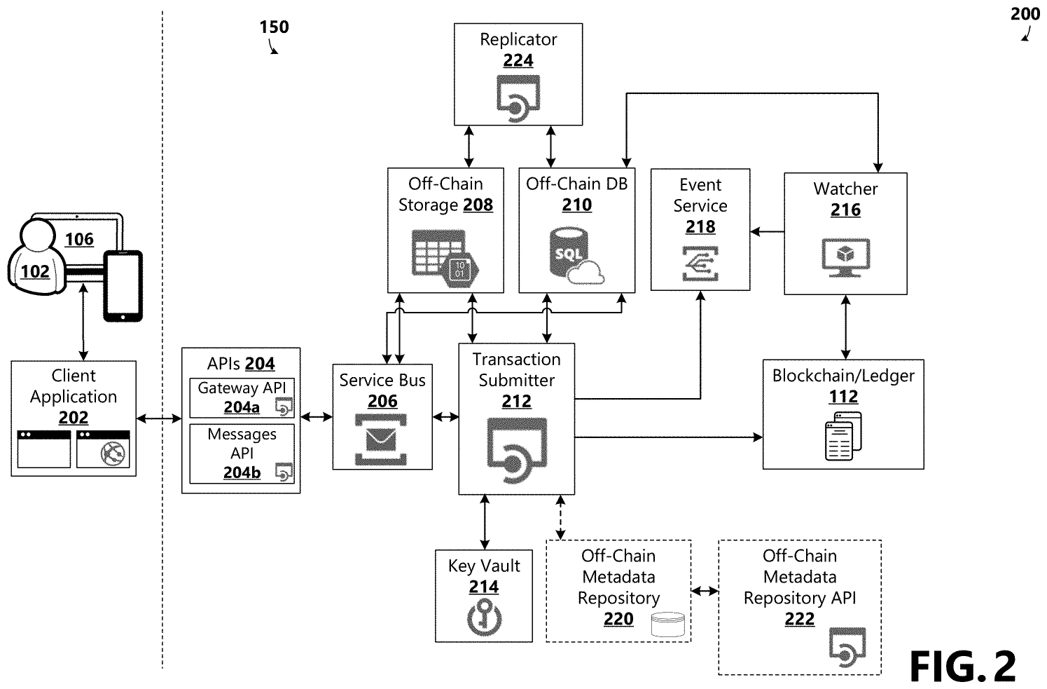

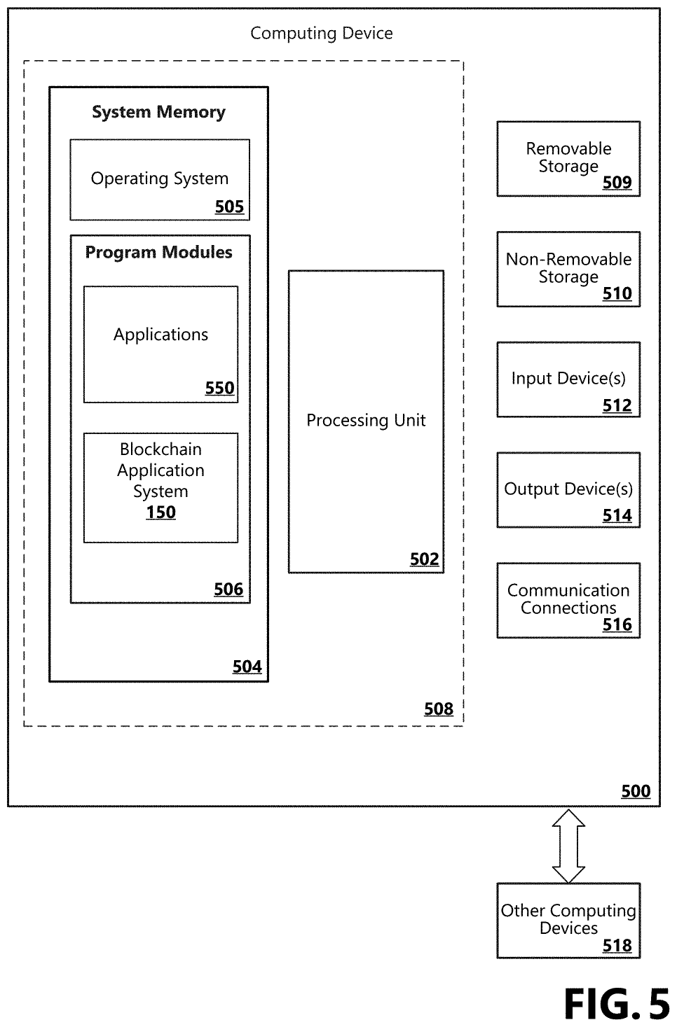

Aspects of the present disclosure are directed to a method, system, and computer readable storage device for providing synchronization and access control of data between multiple parties in a consortium blockchain network and verification of application code submitted by another party in the network. With reference now to FIG. 1, a block diagram is provided showing an example operating environment 100 in which aspects of the present disclosure can be employed, for example, to implement one or more of the components of a blockchain application system 150 as illustrated and described with reference to FIG. 2. It should be understood that this and other arrangements described herein are provided as examples. Other arrangements and elements can be used in addition to or instead of those shown in FIG. 1. Various functions described herein as being performed by one or more elements or components can be carried out by hardware, firmware, and/or software. For example, functions can be carried out by a processor executing instructions stored in memory. As illustrated, the example operating environment 100 includes one or more client computing devices 106, at least one server 108 and a network 110 or a combination of networks. Each of the components illustrated in FIG. 1 can be implemented via any type of computing device, such as the computing devices 500, 600, 705a,b,c described in reference to FIGS. 5, 6A, 6B, and 7. As an example, the one or more client computing devices 106 can be one of various types of computing devices, such as tablet computing devices, desktop computers, mobile communication devices, laptop computers, laptop/tablet hybrid computing devices, large screen multi-touch displays, speaker devices, vehicle computing systems, gaming devices, smart televisions, wearable devices, internet of things (IoT) devices, etc.

The components can communicate with each other via a network 110, which can include, without limitation, one or more local area networks (LANs) or wide area networks (WANs). In some examples, the network 110 comprises the Internet and/or a cellular network, amongst any of a variety of possible public or private networks. As should be appreciated, any number of client computing devices 106 and servers 108 can be employed within the example operating environment 100 within the scope of the present disclosure. Each can comprise a single device or a plurality of devices cooperating in a distributed environment. For example, the server 108 can be embodied as one or more virtual servers implemented on one or more network resources in a distributed environment that collectively provide various functionalities described herein. In some examples, other components not shown can be included within the distributed operating environment 100.

According to an aspect, the example operating environment 100 can be used to implement one or more of the components of a blockchain application system 150 described in FIG. 2, including components for providing various services for creating, deploying, and interacting with distributed applications for enabling sharing business processes and data with various organizations 104a-n (generally 104) in a consortium 109. A blockchain 112 and its data structure are based on a peer-to-peer network that links its members, wherein members participate in the network through a blockchain client node. The data structure of a blockchain corresponds to a linked list of blocks containing transactions also referred to as the ledger 112. The terms “blockchain” and “blockchain ledger” and “ledger” may be used interchangeably, and may be used to describe a record of transactions. Each element of the blockchain ledger 112 may include a pointer to the previous block and embodies its hash value. The blockchain ledger 112 provides an immutable listing of transactions performed in association with a business process. Each node of a consortium 109 may store a local copy of the blockchain ledger 112. A set of cryptographic schemes and distributed systems protocols enable communication among the independent ledgers that ensure the ledger copies stay in sync, that updates are consistent, that the data pushed to the ledger 112 are immutable, and that all state changes are made by authenticated parties.

With reference now to FIG. 2, a block diagram is provided that shows aspects of an example computing system 200 architecture suitable for implementing various aspects of the present disclosure. The blockchain application system 150 illustrated in FIG. 2 represents only one example of a suitable computing system architecture. Other arrangements and elements can be used in addition to or instead of the elements shown. As should be appreciated, elements described herein are functional entities that can be implemented as discrete or distributed components, or in conjunction with other components, and in any suitable combination or location. For example, the components of the blockchain application system 150 can operate on one or more computing devices 106, servers 108 (including virtual servers), can be distributed across one or more computing devices 106 and servers 108 (or virtual server), or can be implemented in the cloud. In some examples, one or more of the components of the blockchain application system 150 are distributed across a network 110 or a combination of networks. In some examples, functions performed by components of the blockchain application system 150 are exposed via one or more APIs (Application Programming Interface). In some examples, components of the blockchain application system 150 receive data from other applications, systems, or services via making calls to APIs of the other applications, systems, or services.

The blockchain application system 150 may allow users 102 to deploy a blockchain 112 and a set of relevant services used to build a distributed application to run on the blockchain. That is, the blockchain application system 150 may automate the configuration of the blockchain infrastructure and cloud services for enabling users 102 to focus on application logic and workflows for a distributed application. An individual (user 102) may select to deploy an instance of the blockchain application system 150, which may then be deployed on one or more resources (e.g., servers 108, virtual servers). In some examples, the instance of the blockchain application system 150 may be deployed and the user 102 (e.g., an organization administrative user of an organization 104) may join an existing consortium 109 responsive to receiving a blockchain platform Proof of Authority (PoA) Remote Procedure Call (RPC) endpoint of an existing consortium network. The deployed instance of the blockchain application system 150 may provide access to a web server 108 that provides a user interface (UI) for display on a client computing device 106 that the individual can use for interacting with the blockchain application system 150 (e.g., via a client application or via an API). Each member of the consortium 109 may run an instance of the blockchain application system 150 on a separate node in the consortium network. As described above, the nodes may be connected to each other so they present a unified consensus on the state of the blockchain ledger 112.

According to an aspect, a user 102 may use the blockchain application system 150 to interact with an executable file deployed on a consortium blockchain 112. The term “executable file” is herein used to describe a program configured to run within a blockchain 112 that comprises a set of rules that constitute an agreement made between two or more parties in a consortium 109. When a set of rules is satisfied, the program (i.e., executable file) executes a transaction on the blockchain 112. An example of an executable file is a smart contract. Other types of executable files are possible and are within the scope of the present disclosure.

According to an aspect, when deployed, the blockchain application system 150 may provide an executable file or may provide tools for generating an executable file that is configured to store data “on-chain” that can be shared amongst consortium members and that can be used to provide access control on distributed applications deployed on the consortium blockchain 112. For example, the executable file may include an on-chain metadata repository including registry data, such as application metadata (e.g., metadata about a distributed application deployed on the blockchain), organization metadata (e.g., metadata about organizations 104 included in the consortium 109, and user metadata (e.g., metadata about users 102 in the organizations who are part of the consortium 109). In example aspects and as will be described in further detail below, the executable file may further include access control rules and role information for providing access control around who is allowed to call various functions in the executable file or in associated distributed applications deployed on the blockchain 112.

The executable file may be deployed at a known address when a blockchain 112 is created. For example, the executable file may be deployed with a first organization 104 when an instance of the blockchain application system 150 is deployed, and other users 102 who want to join the blockchain network (e.g., consortium 109) may be provided with the address of the executable file. The address may be a centralized address that a client or a distributed application can query for application metadata, user metadata, organization metadata, roles, and access control logic. As will be described in further detail below, aspects provide for using the executable file to leverage blockchain technology to securely store various data on-chain to keep the multiple parties in the consortium 109 in sync of these data and to institute on-chain access control.

For example, a member of the consortium 109 may use the blockchain application system 150 to create a distributed application that represents a multi-party workflow defined by configuration metadata and instructions (e.g., associated with self-enforcing business logic) included in the executable file. The configuration metadata for the distributed application may be provided in a configuration file, wherein the configuration metadata represents workflow stages and an interaction model of the distributed application. According to examples, the configuration file may include application metadata (e.g., application name, application description), application roles that define user roles who can act or participate within the distributed application, and one or more workflows that can involve properties, functions, and states that describe the flow of a contract. For example, each workflow in a distributed application may act as a state machine to control the flow of business logic, where taking an action causes the flow of the business logic to move from one state to another. The blockchain application system 150 may support one or more platforms on which the blockchain 112 is deployed. For example, self-enforcing business logic in an executable file may be scripted in a programming language compatible with a particular platform. Each distributed application may comprise state and functions to implement stages and actions of the executable file that defines it, and the information about the transaction itself may be recorded in the blockchain ledger 112.

According to an aspect, a distributed application may be configured to use the executable file as a backend for executing contractual clauses when a preprogrammed condition is triggered. For example, the preprogrammed conditions may be defined by function parameters, that when satisfied, cause the executable file to perform an event that is recorded as a transaction on the consortium blockchain 112. In example aspects, a role may be referenced by a distributed application for enabling access control of a function in the application. The distributed application may include instructions that, when the access-controlled function is called, call the executable file to access role information and logic included in the executable file for verifying whether the individual is associated with a role that is allowed to perform the access-controlled function.

With reference now to FIG. 2, in an example aspect, the blockchain application system 150 is operative or configured to provide a client application 202 (e.g., web application, mobile application, native application), which provides a user-facing front end (e.g., a user interface (UI)) for interacting with an instance of the blockchain application system. The client application 202 can be used to send and receive messages to/from the blockchain application system 150 from a client computing device 106. In example aspects, the blockchain application system 150 exposes one or more API endpoints 204 (e.g., a gateway API 204a, a messages API 204b) that are configured to receive messages (e.g., from the client application 202, sensors, other data sources) and deliver the messages in the correct format to a service bus 206 instance. According to an example, the UI can be used as an interface for creating and interacting with a distributed application and for interacting with executable files that may be included in one or more workflows of the application.

In some examples, the service bus 206 may deliver messages to a transaction submitter 212. The transaction submitter 212 is illustrative of a software application, service, micro-service, module, system, or device operative or configured to receive and process messages to be written to a blockchain ledger 112. In some examples, the transaction submitter 212 includes or is connected to a service configured to retrieve a message comprising metadata for a desired transaction to execute and send the information to the transaction submitter. The transaction submitter 212 may be configured to assemble a blockchain transaction based on the data and the desired blockchain destination. For example, the transaction submitter 212 may assemble a transaction in a format expected by the ledger 112 (e.g., particular to a platform on which the blockchain 112 is deployed) and use particular hashing functions to summarize the data. When the blockchain transaction is assembled, the transaction submitter 212 is further configured to retrieve an appropriate private key stored in a key vault 214 (e.g., a private key for the user 102 who is authenticated when calling the API 204 or delivering the message to the service bus 206), sign the transaction using the right signing algorithm using the key, and send the transaction to the appropriate ledger platform.

According to an aspect, the example computing system 200 architecture may include a watcher 216 component utilized to monitor events occurring on the ledger 112 (and other blockchains attached to the blockchain application system 150). Events may reflect information relevant to individuals (users 102), organizations 104, or the system, such as a creation of a new contract instance, execution of transactions, and changes of states. The watcher 216 may be operative to capture an event and send a message to an outbound message broker such that the event can be consumed by a downstream consumer. In example aspects, the service bus 206 may deliver messages to an off-chain database 210, wherein the off-chain database 210 may reflect a current state shown on the ledger 112. For example, an event may be consumed by the off-chain database 210 and values included in the event message may be populated in the off-chain database, wherein a copy of the ledger 112 enables recreation of a replica of on-chain data in the off-chain database 210. The off-chain database 210 may be used to store contract definitions, configuration metadata, and the replica of data stored in the blockchain 112. In example aspects, the off-chain database 210 is a relational database where the stored data can be easily queried, visualized, or analyzed via access to the database.

In some examples, the service bus 206 may deliver messages to an off-chain storage 208. For example, the off-chain storage 208 may be used as a facility to store data off-chain, such as contracts, metadata associated with contracts, etc. In some examples, the blockchain application system 150 may provide an ability to add documents or other media content with blockchain business logic. For example, a hash of the document or media content may be stored in the blockchain 112, and the actual document or media content may be stored in the off-chain storage 208. Associated transaction information may be delivered by the service bus 206 to the transaction submitter 212, where the transaction information may be packaged, signed, and routed to the blockchain ledger 112. Accordingly, an event may be triggered, which, as described above, may be captured by the watcher 216 and sent to the off-chain database 210 for later querying or consumed by other downstream systems that may consume the event to act as appropriate.

Aspects of the present disclosure provide for leveraging the blockchain ledger 112 network to provide data synchronization between multiple parties in a consortium 109. In a single-party architecture, the blockchain application system 150 may be configured to maintain a mapping between database principals and blockchain addresses, which may be hexadecimal strings based on a user's public key that uniquely identifies the user 102. Via the mapping, a query can be made to the database to access user information associated with the blockchain address (e.g., user's name, email address, title, department, location). However, in a multi-party context, each organization 104 in the consortium 109 may be operating their own directory tenant and may not want to give access to that tenant to people outside the organization. Thus, aspects provide for storing various metadata on-chain in order to identify users 102 or to provide a level of context for enabling users to know who they are interacting with beyond an opaque hexadecimal string.

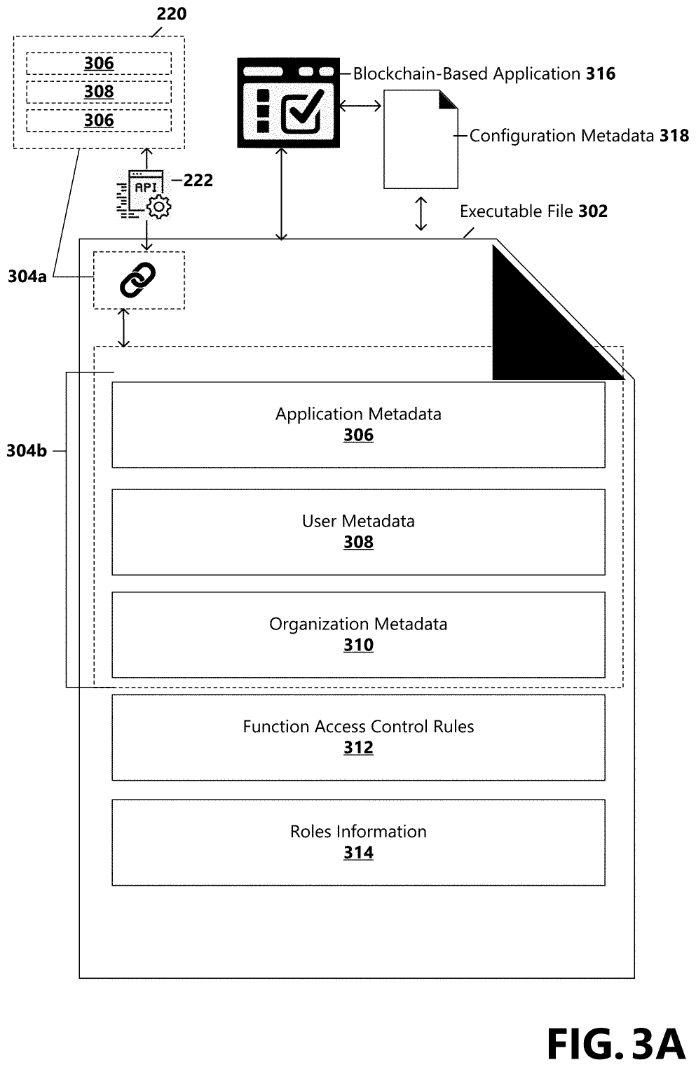

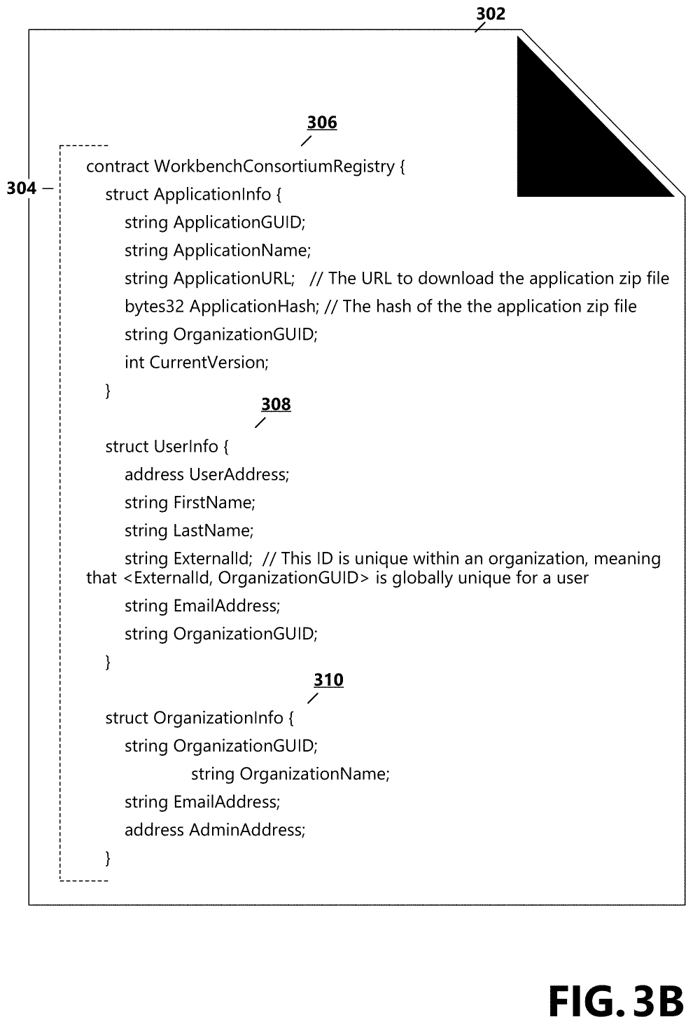

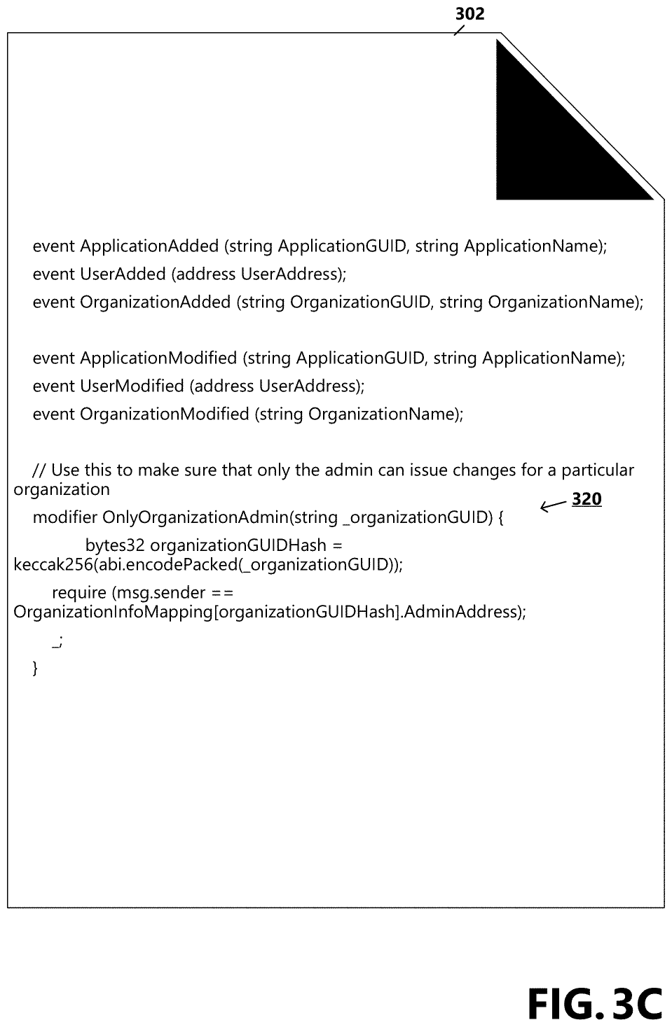

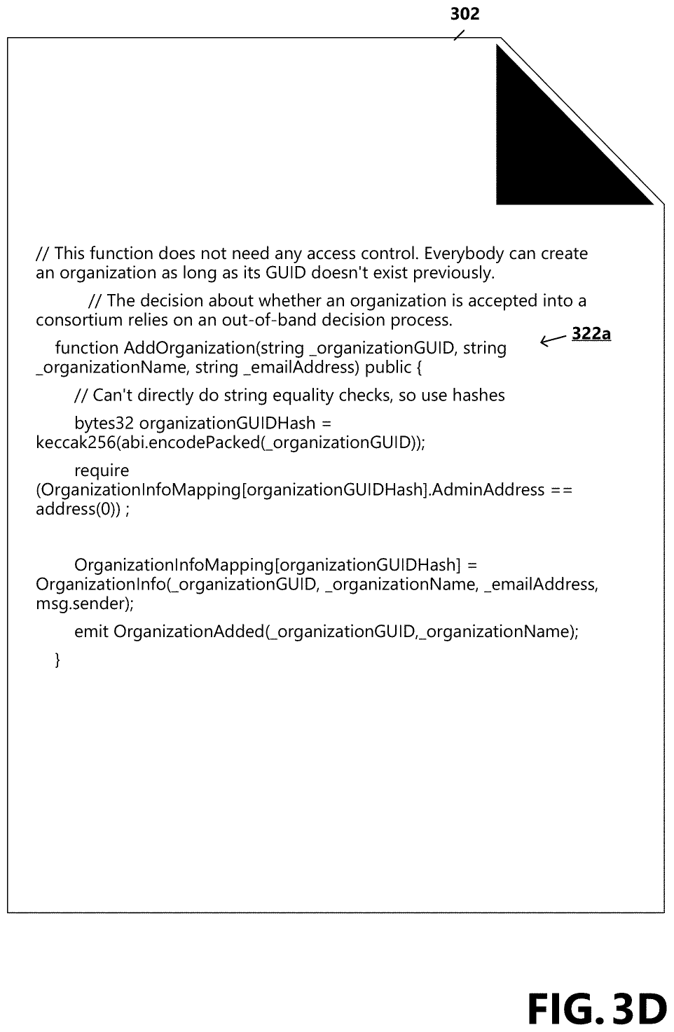

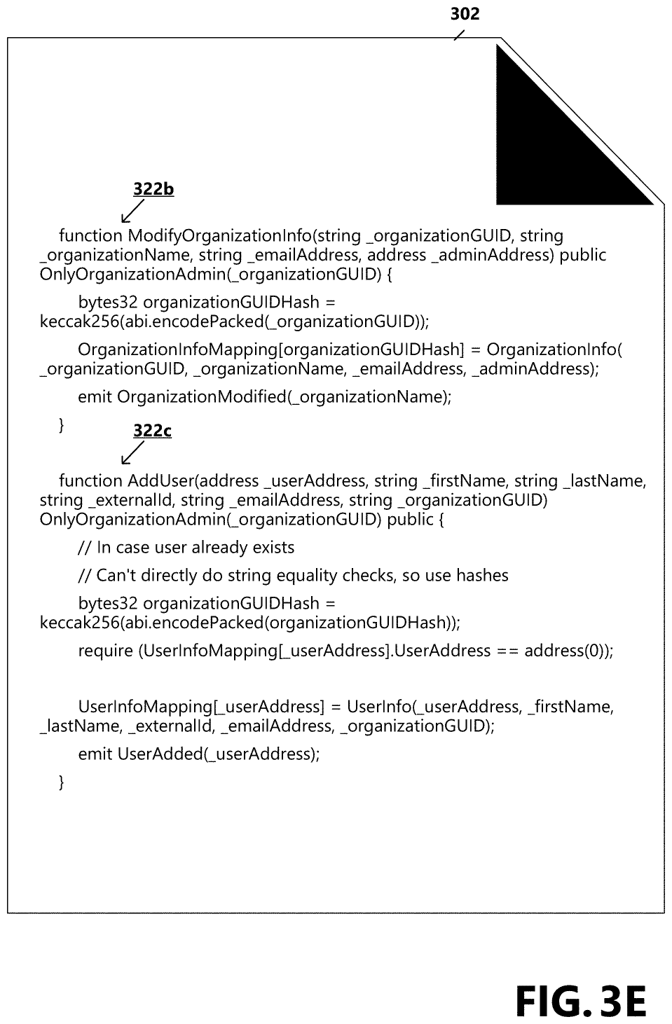

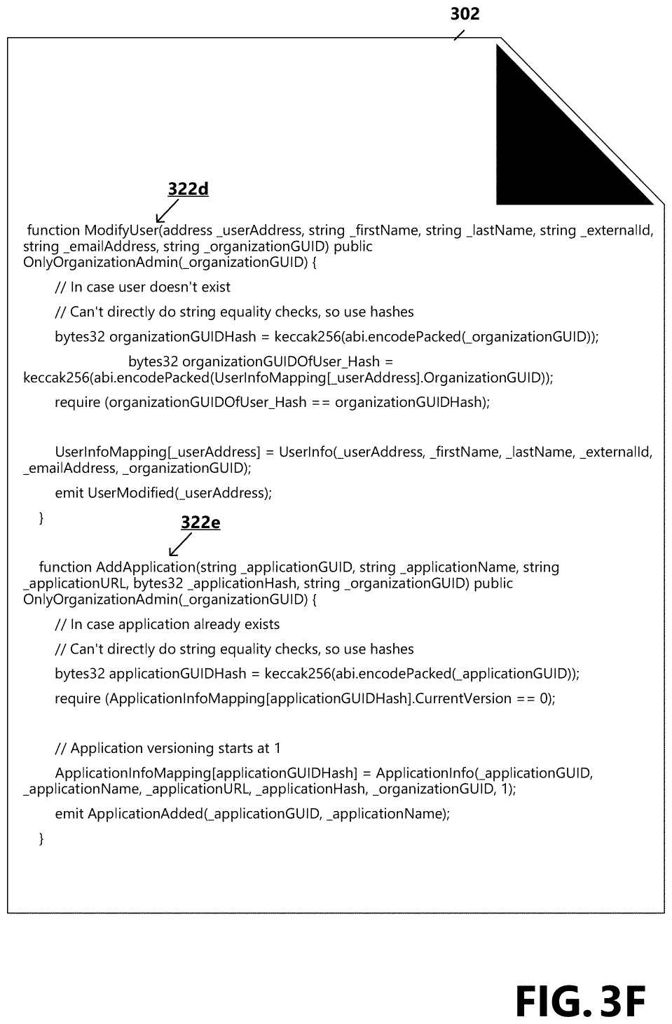

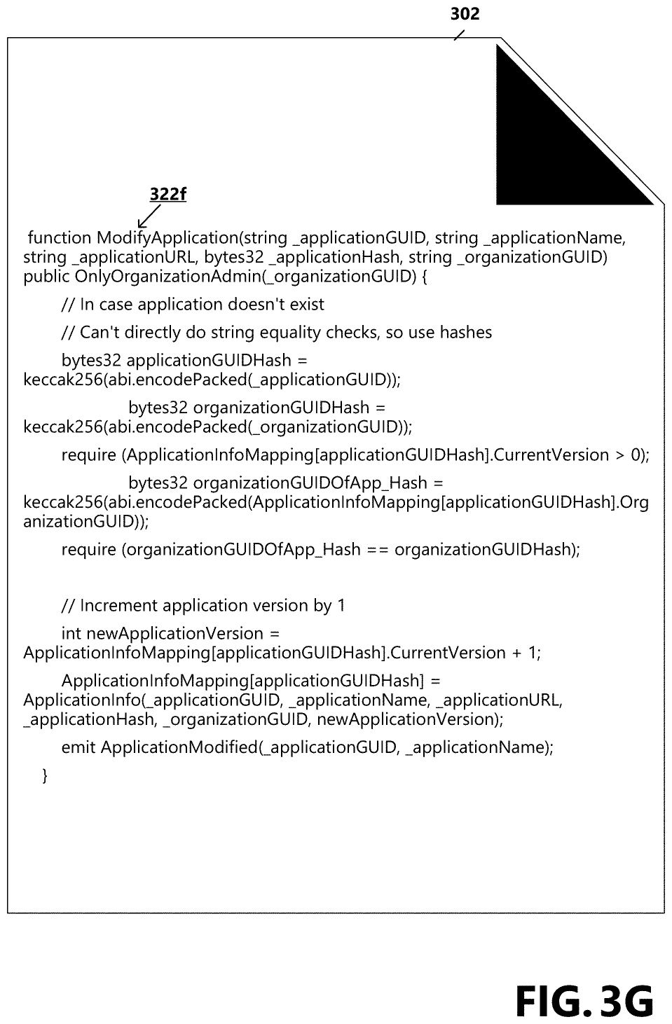

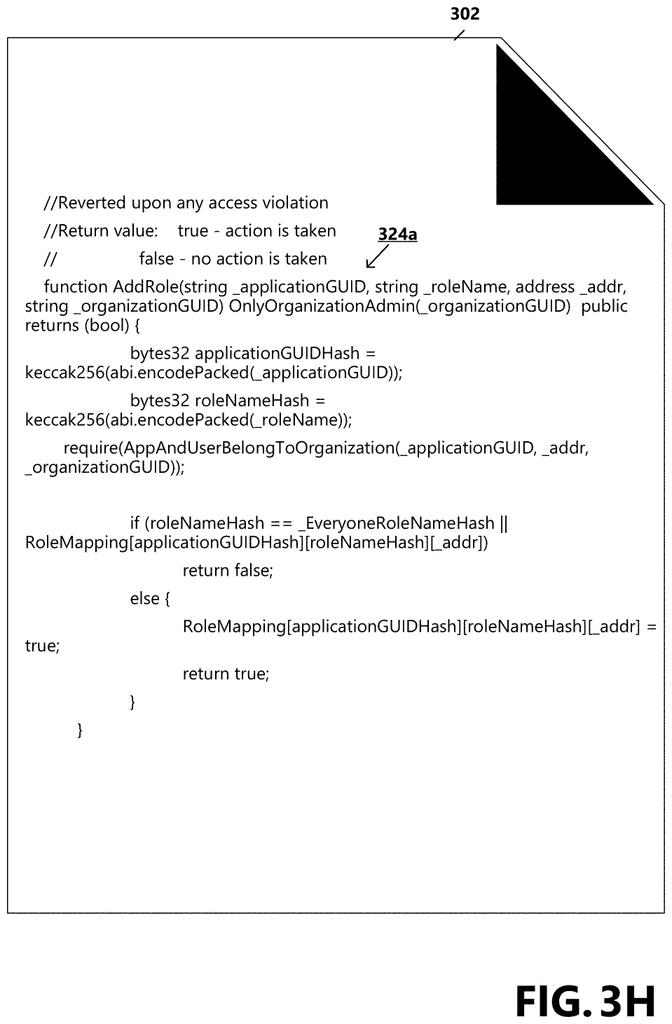

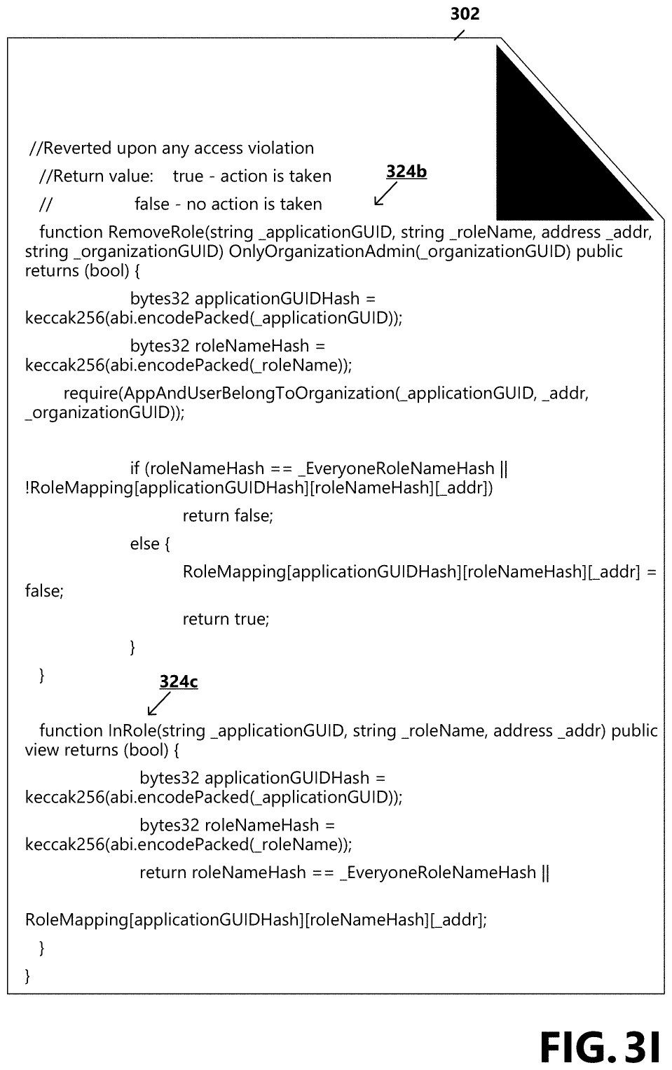

With reference now to FIG. 3A, an illustration of an example executable file 302 including an on-chain metadata repository 304a,b (generally 304) is provided. In some examples, the term “on-chain metadata repository” refers to a repository (304a) included in the executable file 302. In other examples, the term “on-chain metadata repository” refers to a repository (304b) stored in an off-chain metadata repository 220, wherein information of an interface (e.g., the URL of an off-chain metadata repository API 222) that is configured to access the off-chain repository is included in the executable file. For example, the off-chain metadata repository 220 may be implemented for storing registry data (e.g., application metadata 306, user metadata 308, and organization metadata 310) due to blockchain's immutability properties and the GDPR (General Data Protection Regulation) “right to be forgotten” requirement that ‘an individual can make a request to a data controller that all of their personal data be erased without “undue delay” and with no cost to the person making the request.’ Aspects provide further data privacy for registry data. For example, registry data can be kept private from parties who leave a consortium 109 by updating the link interface information (e.g., provide a new URL of the off-chain metadata repository API 222 with a new embedded key). Accordingly, if a party leaves the consortium 109, the access of registry data to the leaving party is revoked.

An example of an on-chain metadata repository 304 included in an example executable file 302 is illustrated in FIG. 3B. Although the on-chain metadata repository 304 is shown as being included in the executable file 302, in other aspects, an address to the off-chain metadata repository API 222 may be included in the executable file for enabling access to the off-chain metadata repository 220 where the registry data may be stored and accessed. In some example aspects, some metadata may be stored in the executable file 302 and other metadata may be stored in the off-chain metadata repository. With reference now to FIG. 3B, the example on-chain metadata repository 304 includes application metadata 306, user metadata 308, and organization metadata 310. For example, user metadata 308 and organization metadata 310 can provide other consortium members transparency into who is making transactions on the blockchain 112 beyond the opaque hexadecimal user identifier string. The transparency enables members of the consortium 109 to easily identify specific organizations 104, users 102, or users of specific organizations, which can foster trust of consortium members in an environment where the parties may or may not be in a trust relationship.

Application metadata 306 may include, but is not limited to: a unique identifier for an associated distributed application 316, an application name, an address for the application file, a hash of the application file, and a unique identifier for the organization 104 associated with the application. User metadata 308 may include, but is not limited to: an address for a user 102 (e.g., hexadecimal public key for the user), the user's name, an external identifier that may be unique within the user's organization 104, an email address, and a unique identifier for the organization. Organization metadata 310 may include, but is not limited to: a unique identifier for the organization 104, the organization's name, an email address for the organization, and an email address of the organization administrator(s). As should be appreciated, more, less, or other types of data may be stored in the on-chain metadata repository 304.

According to an aspect, the executable file 302 may include access control logic associated with additions and/or modifications to the on-chain metadata repository 304. In example aspects, each organization 104 in the consortium 109 may include one or more organizational administrator roles that are authorized to add and modify registry data on behalf of the administrator's organization. Accordingly, only organization administrators may be enabled to add or modify application information 306, add or modify user information 308, or modify organization information 310 stored in the metadata repository (e.g., anyone may be allowed to add an organization to the metadata repository). According to an aspect, the executable file 302 may include various function access control rules 312, which may include one or more modifiers for enabling access control enforcement for particular functions. An example modifier 320 is illustrated in FIG. 3C. For example, when an indication of a transaction is received, the signature of the transaction may be verified to determine whether the organization administrator address is the address from which the transaction originated. Upon verification, the example modifier 320 may be used to allow the organization administrator to make modifications to the corresponding organization's metadata.

With reference now to FIG. 3D, an example of a function 322a that does not include access control in association with registry data is illustrated. For example, the example function 322a enables anyone to add an organization 104 to the network (e.g., decisions about whether an organization 104 is accepted into a consortium 109 may rely on an out-of-band decision process). Alternatively and as illustrated in FIGS. 3E-3G, other example functions 322b-f are illustrated that include access control logic over who can modify organization metadata 310, who can add a user, who can modify user metadata 308, who can add an application (e.g., distributed application 316 to the consortium blockchain 112), and who can modify the application metadata 306.

According to an aspect and as illustrated in FIG. 3H-3I, the executable file 302 may further include role information 314. For example, various roles may be added to the executable file 302 (e.g., role A is comprised of X and Y organizations, role B is comprised of user C from organization Z). By storing the roles in the on-chain metadata repository 304, an associated distributed application 316 can be configured to reference these stored roles for performing verification. For example, the configuration metadata 318 may include instructions to call into the on-chain metadata repository 304 to access the role information 314 for verifying whether a user 102 that is trying to call a particular function (e.g., a state-transitioning function) is in a particular role that is authorized to make the call. Example role functions 324a-c are illustrated in FIGS. 3H-3I, such as an add role function 324a, a remove role function 324b, and an in-role function 324c. For example, when a call is made to execute a function in the distributed application 316, the name of the role may be accessed in the configuration metadata 318, and using the address of the on-chain metadata repository 304, the in-role function 324c may be called to verify whether the person trying to execute the certain function is in an authorized role for executing the function. When a distributed application 316 is being generated using the blockchain application system 150, the blockchain application system may be configured to generate requisite coding for the distributed application 316 to enforce role-mapping defined in the configuration metadata 318 and executable file 302. For example, the configuration metadata 318 may specify that certain functions may be callable by specific roles. Accordingly, when an indication of a transaction that includes an in-role function 324c call is received, a determination may be made as to whether the specific role(s) include the address (i.e., public key) of a user 102 associated with the function call.

In some implementations, the example computing system 200 architecture further includes a replicator 224 operative or configured to provide increased security in a multimember context by enabling verification of source code deployed by another user 102 in the consortium 109. For example, currently, when a distributed application 316 is deployed to the chain, a user 102 may be enabled to access a compiled version, which may be a hexadecimal string. If the user wants to understand how to work with the compiled version of the code, such as to submit certain function calls or to understand the logic behind what the code is trying to do, or if the user wants to verify that the source code has not been maliciously altered, the user may want access to the original source code. In a multi-member context, a user 102/organization 104 may deploy a distributed application 316; however, if the user/organization wants to allow other organizations to work with that application (who may not inherently trust the user/organization), the other organizations may want access to the source code. According to an aspect, the replicator 224 may be configured as an API that sits in front of a storage instance, such as the off-chain storage 208 of each user's blockchain application system 150 instance. When a distributed application 316 is generated by the blockchain application system 150 for a first user 102a, the application metadata 306 included in the on-chain metadata repository 304 may include the address or URL of the first user's replicator 224. Accordingly, when a second user 102b (who may be in a different organization 104 that may not fully trust the first user or first organization) may want to verify the distributed application 316 code, the second user 102b is enabled to use the URL of the first user's replicator to access the source code, pull it down, compile it, and verify that the byte code compiled by their compiler matches the byte code that is deployed on-chain (e.g., by generating and comparing hashes of the code). For example, if the hashes match, the second user 102b can be ensured that the code that they are interacting with on the consortium blockchain 112 is the code they think it is (e.g., that the code has not been compromised). Alternatively, if the byte code hashes to not match, something malicious may be associated with the distributed application 316, and the user/organization may decide not to participate in the distributed application 316. Moreover, when source code is pulled down for verification, the second user's replicator 224 may be further configured to react to the change on the distributed application by replicating the accessed source code, storing the replica in an off-cloud storage on the other consortium node (e.g., off-chain storage 208), and add the URL of the replicator 224 to the executable file metadata repository 304 so that the replica of the source code can be made available to other consortium members. Accordingly, increased data security is provided.

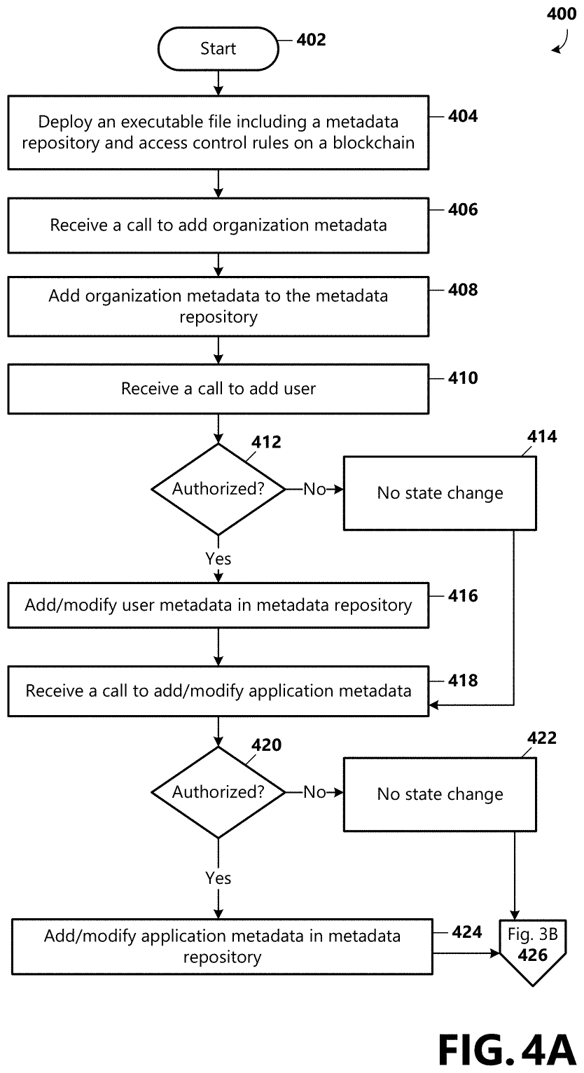

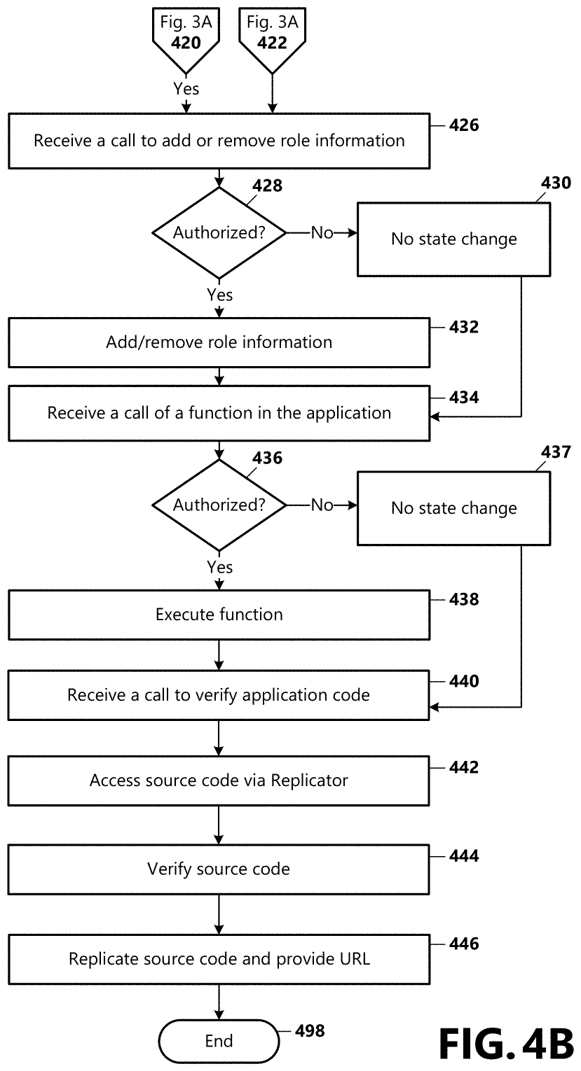

Having described an operating environment 100, an example computing system 200, and an example executable file 302 with respect to FIGS. 1, 2, and 3A-I, FIGS. 4A-B illustrate a flow chart showing general stages involved in an example method 400 for leveraging a blockchain ledger network to provide data synchronization and access control in a consortium network. With reference now to FIG. 4A, the method 400 begins at start OPERATION 402, and proceeds to OPERATION 404, where an executable file 302 is provided. The executable file 302 may be generated and/or deployed at a known address at the time of formation of a blockchain 112 and is configured to interface the blockchain. Accordingly, consortium participants may be provided the known address, which can be used to query for registry data, such as application metadata 306, user metadata 308, and organization metadata 310. In some example aspects, the executable file 302 includes an on-chain metadata repository 304 that is configured to store the application metadata 306, user metadata 308, and organization metadata 310 in the executable file. In other example aspects, the executable file 302 includes an on-chain metadata repository 304 that includes the URL of an off-chain metadata repository API 222, wherein the off-chain metadata repository API 222 can be used to query application metadata 306, user metadata 308, and organization metadata 310 stored in the off-chain metadata repository 220. In other examples, the executable file 302 includes both an on-chain metadata repository 304a that is stored directly in the executable file and an on-chain metadata repository 304b that includes the URL of an off-chain metadata repository API 222 associated with an off-chain metadata repository 220. In example aspects, the executable file 302 and/or the chain metadata repository 304 is further configured to store one or more modifiers 320, function access control rules 312, and/or role information 314.

At OPERATION 406, a call may be received to add organization metadata 310 on-chain. For example, a function 322a may be called to add organization metadata 310 to the on-chain or off-chain metadata repository. The function 322a may not be access-controlled. Accordingly, at OPERATION 408, organization metadata 310 specified by the user may be added to the on-chain metadata repository 304. In one example, the organization metadata may be added to the off-chain metadata repository 220 and the URL of the off-chain metadata repository API 222 may be added to the executable file 302.

At OPERATION 410, a call may be received to add or modify user metadata 308 stored in the metadata repository 304. For example, the add user function 322c or the modify user function 322d may be called. At DECISION OPERATION 412, a determination may be made as to whether the user 102 requesting to add/modify the user metadata 308 is authorized to do so based on the function access control rules 312 included in the executable file 302/metadata repository 304. When a determination is made that the user is not authorized, at OPERATION 414, an exception may be thrown by the executable file 302 and the transaction may roll back the state of the blockchain 112. When a determination is made that the user is authorized, the user metadata 308 may be added or modified in the metadata repository 304. Additionally, the transaction of the added/modified user metadata 308 may be recorded to the blockchain ledger 112, and the state of the transaction may be updated. As described above, the watcher 216 may monitor the ledger 112 for such state change events and send event data to the off-chain database 210 for later querying or to be consumed by other downstream systems.

At OPERATION 418, a call may be received to add application metadata 306 to or modify application metadata 306 stored in the metadata repository 304. For example, the add application function 322e or the modify application function 322f may be called. According to an aspect, the application metadata 306 is associated with a distributed application 316 that is configured to interface the blockchain 112 and use the executable file 302 for core logic of the application.

At DECISION OPERATION 420, a determination may be made as to whether the user 102 requesting to add/modify the application metadata 306 is authorized to do so based on the function access control rules 312 included in the executable file 302/metadata repository 304. When a determination is made that the user is not authorized, at OPERATION 422, an exception may be thrown by the executable file 302 and the transaction may roll back the state of the blockchain 112. When a determination is made that the user is authorized, the application metadata 306 may be added or modified in the metadata repository 304. Additionally, the transaction of the added/modified application metadata 306 may be recorded to the blockchain ledger 112, and the state of the transaction may be updated. As described above, the watcher 216 may monitor the blockchain ledger 112 for such state change events and send event data to the off-chain database 210 for later querying or to be consumed by other downstream systems.

At OPERATION 426 in FIG. 4B, a call may be received to add or remove role information 314. At DECISION OPERATION 428, a determination may be made as to whether the user 102 requesting to add/modify the role information 314 is authorized to do so based on the function access control rules 312 included in the executable file 302/metadata repository 304. For example, if the request is made by a user 102 who does not belong to the same organization 104 associated with the distributed application 316, the determination may result in a false result wherein the addition or modification of role information 314 may not result in a change of state of the blockchain at OPERATION 430. If the user 102 requesting to add/modify the role information 314 is authorized to do so based on the function access control rules 312 included in the executable file 302/metadata repository 304, a transaction may be sent to the blockchain 112 associated with the added/modified role information 314.

At OPERATION 434, a call may be received on a function of the distributed application 316, wherein the function is associated with a state-modifying transaction to the blockchain ledger 112. At DECISION OPERATION 436, a determination may be made as to whether the user associated with the function call is authorized to call the function. For example, at DECISION OPERATION 436, the distributed application 316 may call an in-roll function call of the executable file 302 to make the determination. The request may include an identifier of the distributed application 316, a role name associated with the called function, and an address of the user associated with the function call. The determination may be based on whether the executable file 302 includes role information 314 that specifies that the address of the user associated with the function call is assigned the role name associated with the called function. For example, a determination may be made as to whether the public key/address of the user associated with the function call is stored in a key value store corresponding to the particular role for that distributed application 316. When a determination is made that the user is verified, at OPERATION 438, the application function may execute and a transaction of the executed function may be communicated to the blockchain 112. Alternatively, if the user is not verified, the method 400 may proceeds to OPERATION 437, where an exception may be thrown by the distributed application 316 and the transaction may roll back the state of the blockchain 112.

At OPERATION 440, a call may be received to verify distributed application code. At OPERATION 442, a call may be made to the application contributor's replicator 224 to access the source code. The code may be pulled down and compiled, and a hash of the byte code may be compared with a hash of the byte code deployed on-chain to determine whether the source code is verified at OPERATION 444. At OPERATION 446, the source code may be replicated and stored in the off-chain storage 208, and the URL of the verifier's replicator 224 may be added to the metadata repository 304 for enabling other users to access the replicated source code. The method 400 ends at END OPERATION 498.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are used for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to another aspect, the system memory 504 includes one or more components of the blockchain application system 150. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., one or more components of the blockchain application system 150) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and includes any information delivery medium. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

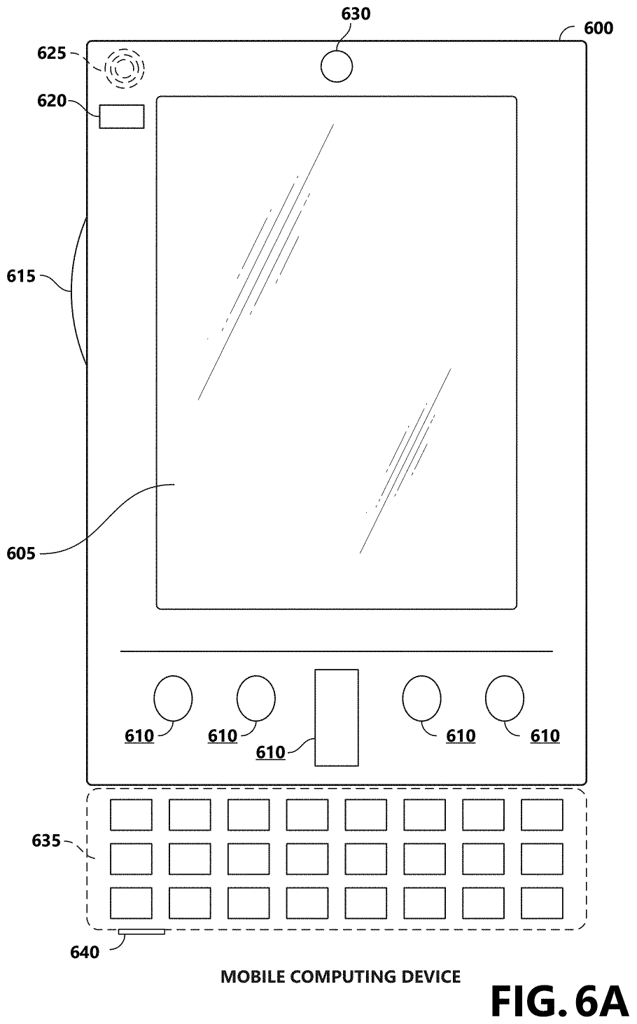

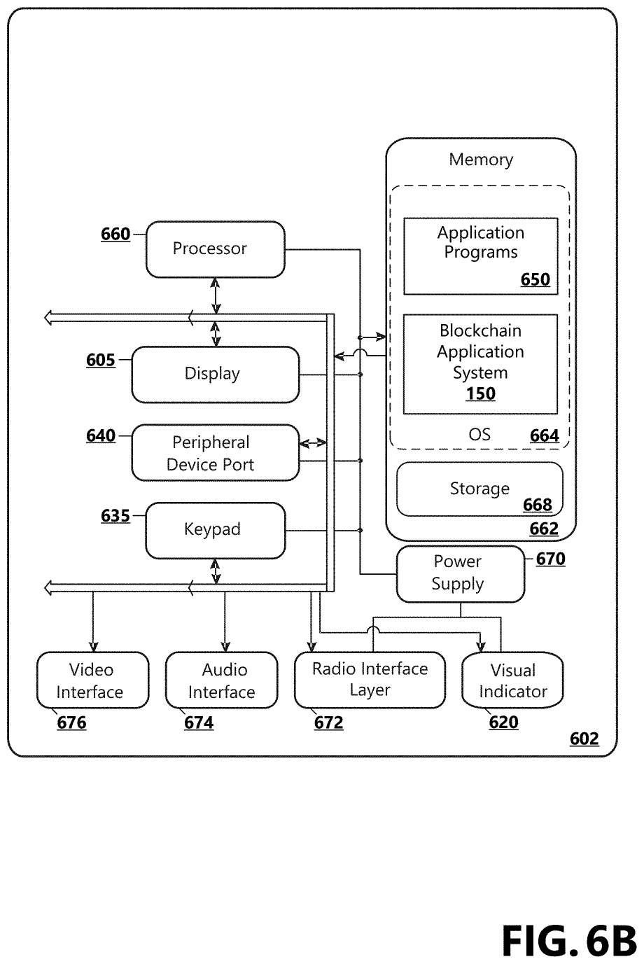

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to another aspect, one or more components of the blockchain application system 150 are loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668. According to an aspect, data/information generated or captured by the mobile computing device 600 and stored via the system 602 is stored locally on the mobile computing device 600, as described above. According to another aspect, the data is stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

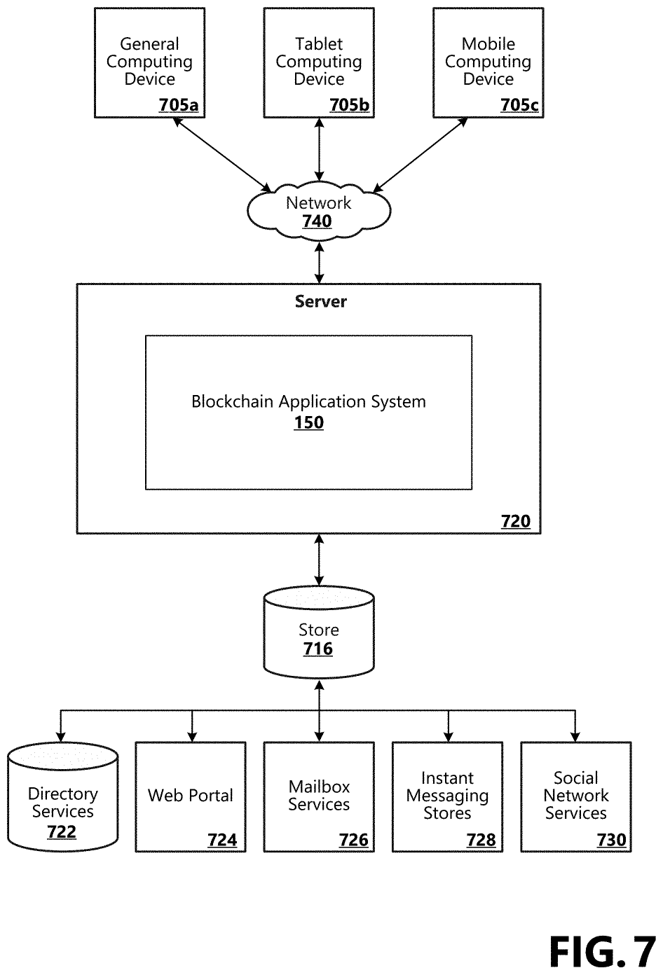

FIG. 7 illustrates one example of the architecture of a system for providing automated quick task notifications via an audio channel as described above. Content developed, interacted with, or edited in association with the one or more components of the audio channel quick task system 200 are enabled to be stored in different communication channels or other storage types. For example, various documents may be stored using a directory service 722, a web portal 724, a mailbox service 726, an instant messaging store 728, or a social networking site 730. One or more components of the blockchain application system 150 are operative or configured to use any of these types of systems or the like for providing automated quick task notifications via an audio channel, as described herein. According to an aspect, a server 720 provides the one or more components of the blockchain application system 150 to client computing devices 705a,b,c. As one example, the server 720 is a web server providing one or more components of the blockchain application system 150 over the web. The server 720 provides one or more components of the blockchain application system 150 over the web to clients 705 through a network 740. By way of example, the computing device is implemented and embodied in a personal computer computing device 705a, a tablet computing device 705b or a mobile computing device 705c (e.g., a smart phone), or other computing device. Any of these examples of the computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for providing on-chain access control, the system comprising:
at least one processing device; and
at least one computer readable data storage device storing instructions that, when executed by the at least one processing device, cause the system to:
deploy an executable file on a record of transactions, wherein the executable file comprises a metadata repository and a function that, when executed, adds a transaction to the record of transactions;
responsive to receiving a call of the function, determine whether the function is access-controlled;
when the function is access-controlled, determine whether a user associated with the function call is authorized to call the function; and
when the user is authorized:
assemble a transaction based on information included in the function call; and
route the transaction to the record of transactions.

2. The system of claim 1, wherein the transaction modifies a state of the metadata repository on the record of transactions.

3. The system of claim 2, wherein the function call comprises one of:
a call to add user metadata to the metadata repository;
a call to modify user metadata stored in the metadata repository;
a call to add application metadata to the metadata repository;
a call to modify application metadata stored in the metadata repository; or
a call to modify organization metadata stored in the metadata repository.

4. The system of claim 1, wherein the metadata repository is stored in the executable file.

5. The system of claim 1, wherein:
the metadata repository comprises an off-chain metadata repository; and
the executable file includes an address of an interface that provides access to the off-chain metadata repository.

6. The system of claim 1, wherein determining whether the user associated with the function call is authorized to call the function further comprises:
accessing the metadata repository to determine whether an address associated with the user is an address of an organization administrator role authorized to call the function.

7. The system of claim 1, wherein the system is further configured to:
generate an application based on the executable file, wherein the application is configured to interface the record of transactions; and
use metadata stored in the metadata repository to enforce access control logic in the application.

8. The system of claim 7, wherein generating the application further comprises:
receiving configuration metadata for the application, wherein the configuration metadata defines one or more user roles associated with an authorization to interact with the application;
store the one or more user roles with one or more addresses of users associated with the one or more user roles in the metadata repository; and
generate code for the application including a reference to call the metadata repository for enforcing access control associated with the one or more user roles.

9. The system of claim 7, wherein the system is further configured to:
responsive to receiving a call of a function included in the application associated with a state-modifying transaction to the record of transactions:
make a call to the metadata repository for determining whether an address associated with a requestor of the state-modifying transaction matches the address of a user associated with the one or more user roles; and
when the address associated with the requestor matches the address of a user associated with the one or more user roles, route the state-modifying transaction to the record of transactions.

10. The system of claim 7, wherein:
the record of transactions is a blockchain;
the blockchain is accessible by one or more users included a plurality of organizations; and
the plurality of organizations is in a consortium.

11. The system of claim 10, further comprising a replicator, wherein the system is further configured to:
store an address of the replicator in the metadata repository;
receive an indication of a request from a user in the consortium for source code of the application, wherein:
the source code is stored in an off-chain storage, and
wherein the request is directed to the address of the replicator;
use the replicator to access the source code; and
provide the source code to the requesting user for enabling verification of the source code by the user.

12. The system of claim 11, wherein the replicator is further configured to :
receive, from another user in the consortium, source code of another application configured to interface the record of transactions;
replicate the source code;
store the replica of the source code in an off-chain storage; and
add an address of the replicator to the metadata repository for enabling another user in the consortium to access and verify the source code of the application.

13. A computer-implemented method for providing on-chain access control, the method comprising:
deploying an executable file on a record of transactions, wherein the executable file comprises a metadata repository and a function that, when executed modifies a state of the metadata repository;
responsive to receiving a call of the function, determining whether the function is access-controlled;
when the function is access-controlled, determining whether a user associated with the function call is authorized to call the function; and
when the user is authorized:
assemble a transaction based on information included in the function call; and
route the transaction to the record of transactions for modifying the state of the metadata repository.

14. The method of claim 13, wherein providing access to the metadata repository in the executable file comprises one of:
providing an executable file comprising the metadata repository; or
providing an executable file comprising an address of an interface that provides access to an off-chain metadata repository.

15. The method of claim 13, wherein determining whether the user associated with the function call is authorized to call the function comprises making a call to the metadata repository for determining whether an address associated with the user matches an address of an organization administrator role authorized to call the function.

16. The method of claim 13, further comprising:
generating an application based on the executable file; and
using metadata stored in the metadata repository to enforce access control logic included in the application.

17. The method of claim 16, wherein generating the application comprises:
receiving configuration metadata for the application defining one or more user roles associated with who can interact with the application;
storing the one or more user roles with one or more addresses of users associated with the one or more user roles in the metadata repository; and
generating code for the application including a reference to call the metadata repository for enforcing access control associated with the one or more user roles.

18. The method of claim 17, further comprising:
receiving an indication of a function call in the application associated with a state-modifying transaction to the record of transactions;
making a call to the metadata repository for determining whether an address associated with a requestor of the state-modifying transaction matches the address of a user associated with the one or more user roles; and
when the address associated with the requestor matches the address of a user associated with the one or more user roles, routing the state-modifying transaction to the record of transactions.

19. The method of claim 13, further comprising:
sending a request to another user for source code of another application configured to interface the record of transactions;
receiving the source code;
replicating the source code;
storing the replica of the source code in an off-chain storage; and
adding, to the metadata repository, an address of an interface to the off-chain storage for enabling another user authorized to access the other application to access and verify the source code of the other application.

20. A computer readable storage device including computer readable instructions, which when executed by a processing unit the processing unit is configured to:
deploy an executable file on a record of transactions comprising a metadata repository and at least one function that, when executed, modifies a state of the metadata repository, wherein the metadata repository is one of:
an on-chain metadata repository included in the executable file; or
an off-chain metadata repository, wherein an address of an interface for accessing the off-chain metadata repository is included in the executable file;
responsive to receiving a call of the at least one function, determine whether the at least one function is access-controlled;
when the at least one function is access-controlled, determine whether a user associated with the function call is authorized to call the at least one function;
when the user is authorized:
assemble a state-modifying transaction based on information included in the function call; and
route the transaction to the record of transactions for modifying the state of the metadata repository;
generate an application based on the executable file; and
use metadata stored in the metadata repository to enforce access control logic in the application.
